(19) United States
(12) Patent Application Publication
(10) Pub. No.: US 2024/0245012 A1
(43) Pub. Date: Jul. 25, 2024

(54) Self-Contained Device for Heating Plants

(71) Applicant: WINEPROTECT, LUDON MEDOC (FR)

(72) Inventors: Mathieu DUCAMP, LUDON MEDOC (FR); Déborah DUCAMP, LUDON MEDOC (FR)

(21) Appl. No.: 18/040,093

(22) PCT Filed: Jul. 29, 2021
(86) PCT No.: PCT/EP2021/071318

§ 371 Date: Feb. 24, 2023

(30) Foreign Application Priority Data
Jul. 31, 2020 (FR) FR2008214

(51) Int. Cl. A01G 13/06

(52) U.S. Cl. CPC A01G 13/06

(57) ABSTRACT

Said device (1) comprises a radiation and/or convection heater element (3), a main housing (5) incorporating an electronic control system and a battery configured to power the electronic control system, an upper housing (8) comprising a photovoltaic panel suitable for charging the battery, the device (1) further comprising a removable stake (7) removably attached to the main housing (5) and suitable for securing the device (1) in the soil.

The present invention relates to devices for heating plants making it possible to maintain the temperature of the cultivated plants.

The present invention aims to constitute a self-contained device, that is to say one that stores energy by photovoltaic effect, and which automatically activates in the event of low temperature, making it possible to keep frost off plants and in particular vines, for as long as the plant is growing.

### PRIOR ART

Heating systems are known which make it possible to maintain the temperature of plants. Nevertheless, known systems are not self-contained, both in energy and in operation, which prevents them from being left outside or entails requiring remote activation. There are also self-contained systems which store the heat and deliver it, which only allows minimal and short-term heating, these systems also being not controllable by the user.

The need to overcome the problems encountered on existing devices led to the present invention.

### SUMMARY OF THE INVENTION

The object of the invention is to overcome at least some of the aforementioned drawbacks and to propose a device for heating plants in soil that combines the advantages of autonomy, simplicity, and reliability for the implementation thereof.

In view of the foregoing, the subject matter of the invention is a device comprising a heating element, a main housing incorporating an electronic control system and a battery configured to power the electronic control system, an upper housing comprising a photovoltaic panel adapted for charging said battery, the device further comprising a removable stake removably attached to said main housing and suitable for securing the device in the soil.

Preferably, the device comprises means for stacking said device on another copy of the same device whose removable stake has been removed, the stacking means being arranged on the one hand on the main housing and on the other hand on the upper housing.

For example, the stake is adapted to be able to be removably fitted onto the stacking means arranged on the main housing.

Advantageously, the upper housing comprises a disc plate and the photovoltaic panels cover said disc plate, and the stacking means arranged on the upper housing are cylindrical and centered on the center of the disc plate.

According to one embodiment, the heating element is adapted to emit radiation heating and comprises a light-emitting diode with infrared emission surrounded by an optical diffuser.

In one embodiment, the optical diffuser comprises acrylic.

In another embodiment of the invention, the heating element may comprise a light source and a reflector, in particular a dichroic reflector. This type of reflector makes it possible to reflect only the infrared radiation from the light source. If appropriate, the light source may comprise a halogen lamp.

Advantageously, the electronic control system comprises a temperature sensor configured to switch on the heating element as soon as the measured temperature passes below a pre-configured threshold temperature.

The device may further comprise a light-emitting diode that integrates the main housing and which is configured to indicate the current operation of the device.

Preferably, at least one of the main housing and the upper housing comprises high-density polyethylene.

The invention also relates to a device having a cap covering the stacking means arranged on the upper housing.

In an example embodiment of the invention, the heating element may be integrated into the main housing.

In another example embodiment of the invention, the heating element may be removable from the main housing, the heating element being electrically connected to the main housing, and in particular to the battery and/or to the electronic control system, by one or more electrical connection cables. In this embodiment, the heating element can thus be secured as close as possible to the plant intended to be heated.

Advantageously, the heating element may comprise an attachment member, for example a hook or a clip. This attachment member makes it possible in particular to secure the heating element to a support device of the plant intended to be heated, such as a post, a stake or even a tying wire, of the bearing or lifting type.

Preferably, the device according to the invention may comprise a plurality of heating elements each electrically or indirectly connected to the main housing. For example, the heating elements may be mounted in series with one another and with the main housing.

The invention will be better understood through detailed study of some embodiments taken by way of non-limiting examples and shown by the appended drawings, in which:

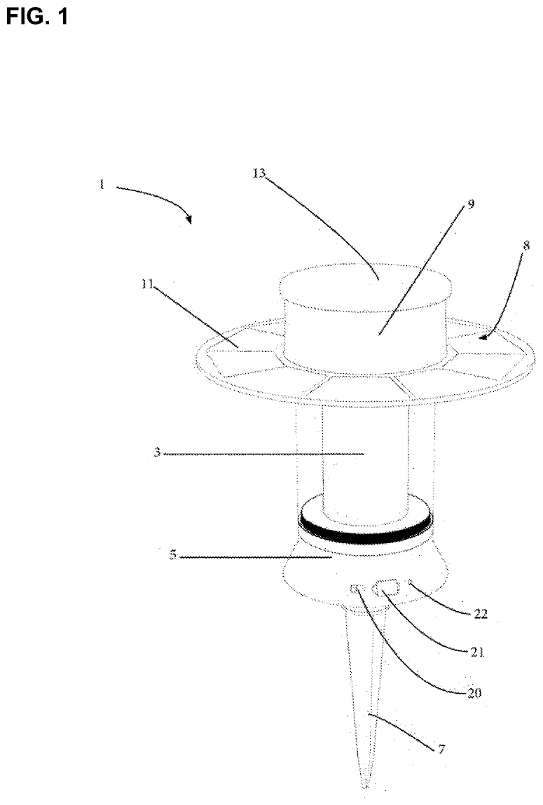

FIG. 1 shows a front view of a heating device according to a first embodiment of the invention;

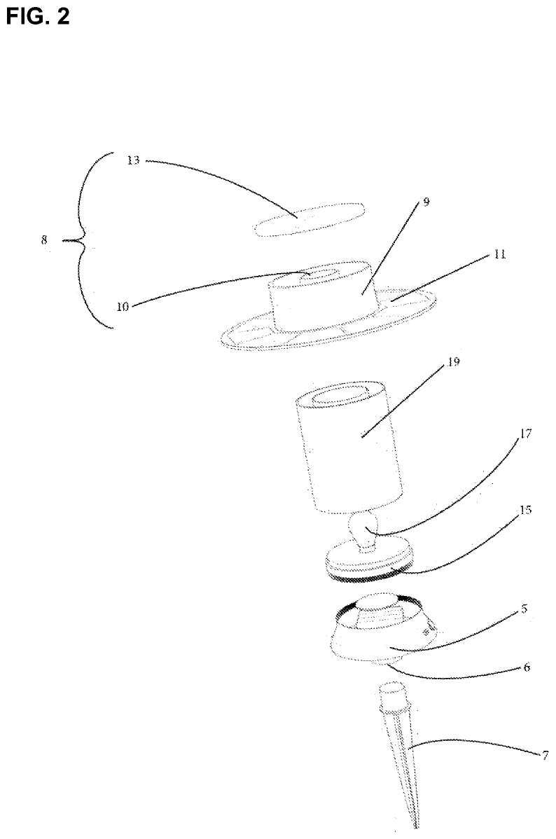

FIG. 2 shows an exploded view of the same device;

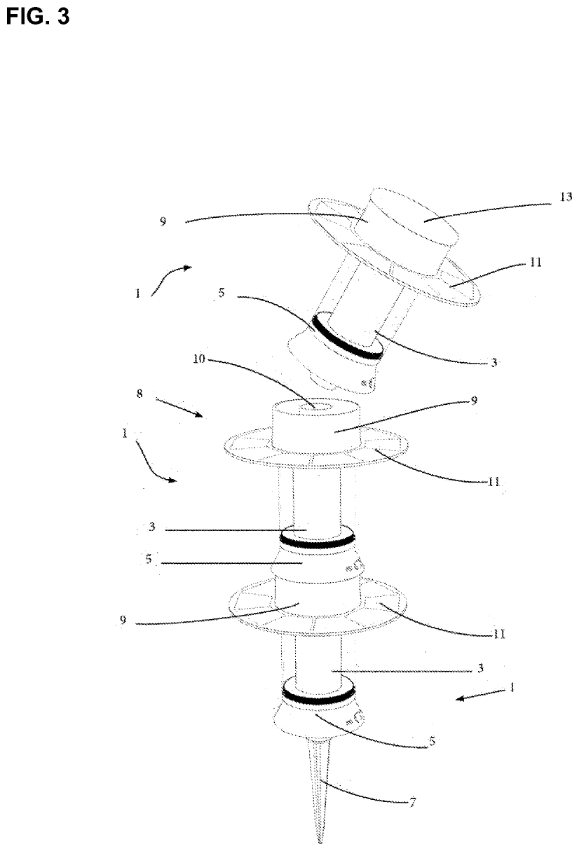

FIG. 3 shows a front view of three devices of the invention that are stacked;

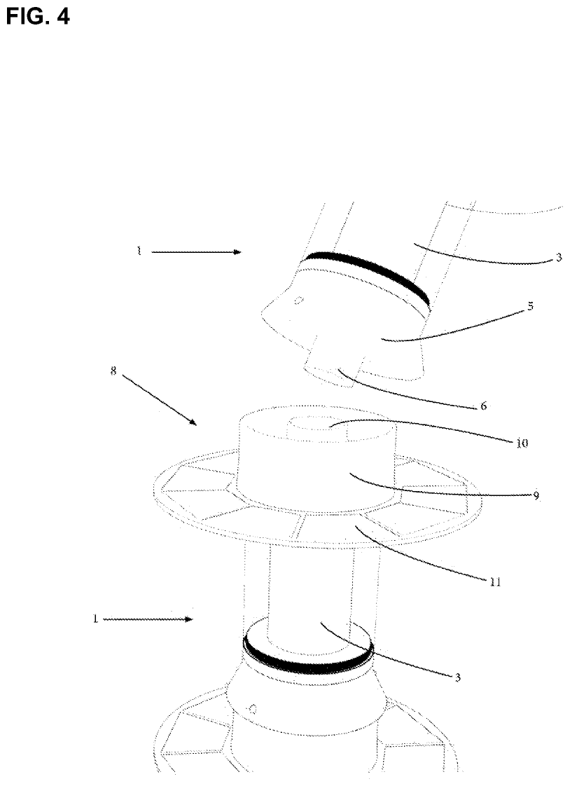

FIG. 4 shows a detailed view of the stacking means;

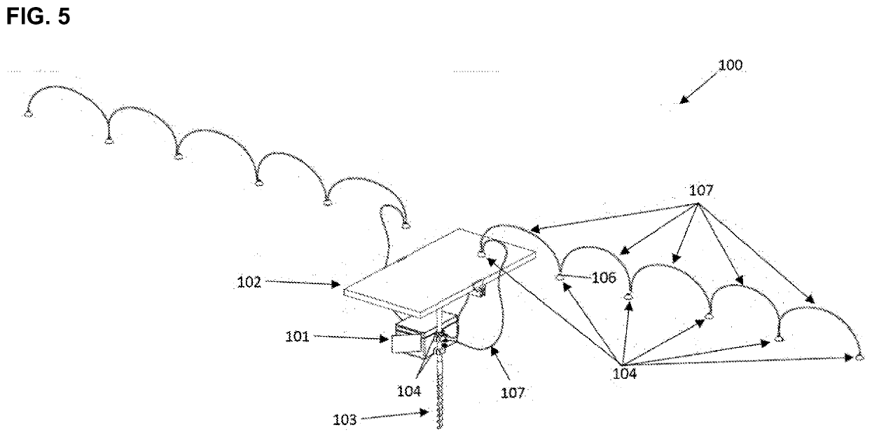

FIG. 5 shows a perspective view of a heating device according to a second embodiment of the invention.

### DETAILED DESCRIPTION OF THE FIGURES

FIG. 1 shows the device 1 allowing the heating of plants in the soil.

For this purpose, the device 1 comprises a heating element 3.

The heating element 3 may be configured to emit radiation heating, convection heating or a combination of both.

“Radiation heating” means heat radiating from said element 3 and towards the different surfaces encountered by the emitted rays.

This heating element 3, if it is suitable for radiation heating, is adapted to emit heating by direct radiation towards the surfaces on the ground and surrounding areas there when an electric current passes through it.

For example, the heating element 3 configured for radiation heating comprises a light-emitting diode 17 with infrared emission.

This produces a device 1 generating radiation heating that minimizes the radiation visible to humans, and therefore unwanted illumination. Infrared radiation is particularly recommended for plants, in particular vines.

As shown in FIG. 2, the infrared diode 17 may be surrounded by an optical diffuser 19, making it possible to protect the infrared diode 17 and to direct its radiation over all of the surrounding areas.

The optical diffuser 19 may comprise acrylic, resistant and transparent material particularly suitable for the desired light scattering.

The optical diffuser 19 is composed of two concentric covers which scatter the light produced by the infrared diode 17.

The heating element 3 can be configured to emit convection heating, that is to say which heats the surrounding air.

The heating element 3, if it is suitable for convection heating, may be configured as a convector, that is to say for heating the air located around the device 1 by a heating body, for example by the Joule effect, and in order to allow, at the same time, air circulation by virtue of a blowing member.

The blowing member is therefore integrated into the heating element 3, so that its blowing function is coupled to that of heating of the device 1.

It is in particular possible to provide a heating element 3 comprising a heating body onto which a blowing member (not shown) of the electric fan type known to those skilled in the art blows.

The blowing member may or may not be coupled to a heating function by radiation of the heating element 3.

Thus, the heating element 3 can for example emit heating by direct radiation toward a specific surface of the heating element 3, in particular of the heating body, onto which the blowing member blows, which makes it possible to combine the convection and radiation heating of the heating element 3.

Furthermore, the device 1 thus recovers the natural circulation movement of air caused by the temperature differences between the ambient air and the heating element.

In all of its possible embodiments, the heating element 3 therefore makes it possible both to assist the heating and the movement of the surrounding air in order to reduce the accumulation of frost.

The device 1 comprises a main housing 5 situated under the heating element 3.

The main housing 5 incorporates an electronic control system and a rechargeable battery.

The rechargeable battery may of course consist of a plurality of coupled batteries, in particular rechargeable cells or a main battery coupled to an auxiliary battery.

The electronic control system contains a PCB, the rechargeable battery, and the internal electronic components of the device 1, in particular the heating element 3 and the possible fan.

The rechargeable battery is configured to electrically power said electronic control system.

The device 1 further comprises an upper housing 8 overhanging the heating element 3.

Preferably, at least one of the main housing 5 and the upper housing 8 comprises high-density polyethylene, this material being particularly stable and resistant.

The upper housing 8 comprises an outer cylindrical wall 9.

The upper housing 8 supports a photovoltaic panel used to convert sunlight into electricity.

The photovoltaic panel is therefore suitable for charging the battery during the day thanks to the solar radiation, so that the device 1 can be activated at night by the electrical energy accumulated in the battery, since it is essentially all night long that it is important to prevent the formation of frost on the vines.

It is further possible to provide a recharging port 21 making it possible to recharge the battery by connecting a power supply cable connected to the electrical network.

The upper housing 8 may comprise a disc plate 11.

As shown, the plate 11 is arranged above the heating element 3 and so that the photovoltaic panels cover the disc plate 11.

Thus, the disc plate 11 allows optimum exposure of the photovoltaic panel, but also a concentration and a downward return of the heat produced by the heating element 3.

The electronic control system may comprise a temperature sensor of the thermostat type configured to turn on the heating element 3 (and therefore presumably if appropriate, to turn on the blowing member of the heating element 3) as soon as the measured temperature falls below a pre-configured threshold temperature.

For example, a threshold temperature of four degrees Celsius will be configured, below which the sensor triggers the activation of the heating function.

It further is possible to provide that a crossing of a maximum temperature threshold detected by the same sensor triggers the deactivation of the device 1, for example on the order of five degrees, in order to avoid any overheating.

It may be provided that the automatic activation can be authorized only after switching on an activation control switch 20, this same switch 20 therefore serving to extinguish the device 1.

The device may further comprise a light-emitting diode 22 incorporated into the main housing 5, configured to indicate the current operation of the device 1.

Thus, it is possible to immediately identify the devices 1 which are in the process of heating the plants in the soil, for example if the diode 22 is lit and green, whereas this diode 22 not being lit indicates that the device 1 is turned off.

The same diode 22 can also light up in other colors to provide other indications, for example red to indicate standby mode or orange to indicate a need to recharge the battery.

As shown more particularly in FIG. 3, the device 1 comprises means 6, 10 for stacking said device 1 on another copy of the same device 1.

It is thus possible to place a device 1 on the wall 9 in order to form a tower having a plurality of devices 1 so as to adapt the heat supply to the height of the plants to be heated, which is particularly advantageous in the case of climbing vines.

The wall 9 serves as a reinforcing element structuring the tower thus formed. A maximum stacking of five units of the device 1 is notably allowed for.

The stacking means 10 which are arranged on the upper housing 8 are cylindrical and centered on the center of the disc plate 11, concentrically relative to the panel also centered on the disc plate.

As shown by FIG. 4, the stacking means on the upper base 9 comprise, in this example, a female element formed of a wide tube 10, adapted to accommodate the stacking means arranged on the upper base 9 formed of a male element 6 consisting of a less wide tube 6.

Thus, the less wide tube 6 constitutes a hollow male element.

The surface of the photovoltaic panel exposed to the sun is thus uniformly distributed towards the periphery of the disc plate 11, which increases the daily exposure time to the sun of said panel relative to configurations in which the panel would not be thus centered.

The device 1 further comprises a removable stake 7 removably attached to said main housing 5 and suitable for securing the device 1 in the soil.

For example, the stake 7 is adapted to be able to be removably fitted onto the stacking means 6 arranged on the main housing 5.

Thus, the hollow part of the hollow male element 6 which consists of a hollow tube 6, constitutes a connector suitable for accommodating the stake 7.

In particular, it comprises in a known manner a pointed extension connected by four substantially perpendicular thin walls.

The stake 7 has an elongation of the order of one-hundred sixty millimeters, when the total height of the device equipped with a stake 7 is of the order of four-hundred millimeters.

When the removable stake 7 is removed, the stacking means 6, 10 arranged on the one hand on the main housing 5 and on the other hand on the upper housing 8 allow for two devices 1 to be fitted on.

The device 1 may further comprise a cap 13 covering the stacking means 10 arranged on the upper housing 8, which makes it possible to protect the upper housing 8.

FIG. 5 shows a heating device 100 according to another example embodiment of the invention.

In a manner similar to the device 1 of the preceding figures, this device 100 comprises a main housing 101 incorporating an electronic control system and a rechargeable battery as well as an upper housing 102 supporting a photovoltaic panel making it possible to charge the battery of the main housing 101. Since these elements are substantially identical to those of FIG. 1, they will not be described again.

The device 100 further comprises a removable stake 103 removably attached to said main housing 101 and suitable for securing the device 100 in the soil. In this example, the stake 103 is secured to the main housing 101 via tightening means 104 provided with a housing making it possible to receive and retain the stake 103. It will further be noted that in this example, the stake 103 supports the upper housing 102, which is therefore connected to the main housing 101 only by an electrical cable.

The heating device further comprises a plurality of heating elements 105. Each heating element 105 comprises a halogen lamp and a dichroic reflector 106 on which a securing hook is attached. Each heating element 105 can thus be secured, via a securing hook, onto a tying wire of a cultivation, whether a bearing or a raising one, in order to be positioned as close as possible to one or several plants intended to be heated.

The heating elements 105 are electrically connected in series to one another by cables 107, as well as to the main housing 101, in order to be able to be controlled and powered.

1. A heating device (1, 100) for plants comprising a heating element (3, 105), a main housing (5, 101) incorporating an electronic control system and a battery configured to power said electronic control system, an upper housing (8, 102) comprising a photovoltaic panel suitable for charging said battery, the device (1) further comprising a removable stake (7, 103) removably attached to said main housing (5, 101) and suitable for securing the device (1, 100) in the soil.

2. The device (1) according to claim 1, further comprising means for stacking (6, 10) said device (1) on another copy of the same device (1) and whose removable stake (7) has been removed, the stacking means (6, 10) being arranged on the one hand on the main housing (5) and on the other hand on the upper housing (8).

3. The device (1) according to claim 2, wherein the stake (7) is adapted to be able to be removably fitted onto the stacking means (6) arranged on the main housing (5).

4. The device (1) according to any one of claims 2 and 3, wherein the upper housing (8) comprises a disc plate (11) and the photovoltaic panels cover said disc plate (11), and the stacking means (10) arranged on the upper housing (8) are cylindrical and centered on the center of the disc plate (11).

5. The device (1) according to any one of the preceding claims, wherein the heating element (3) is configured to emit radiation heating, the heating element (3) comprising a light-emitting diode with infrared emission (17) surrounded by an optical diffuser (19).

6. The device (1) according to claim 5, wherein the optical diffuser (19) comprises acrylic.

7. The device (100) according to any one of the preceding claims, wherein the heating element (105) comprises a light source and a reflector (106).

8. The device (1) according to any one of claims 1 to 4, wherein the heating element (3) is configured to emit convection heating, the heating element (3) comprising a blowing member.

9. The device (1, 100) according to any one of the preceding claims, wherein the electronic control system comprises a temperature sensor configured to switch on the heating element (3, 105) as soon as the measured temperature passes below a pre-configured threshold temperature.

10. The device (1, 100) according to any one of the preceding claims, wherein at least one of the main housing (5, 101) and the upper housing (8, 102) comprises high-density polyethylene.

11. The device (1) according to any one of the preceding claims combined with claim 2, comprising a cap (13) covering the stacking means (10) arranged on the upper housing (8).

12. The device (100) according to any one of the preceding claims, wherein the heating element (105) is removable with respect to the main housing (101), the heating element being electrically connected to the main housing by one or several electrical connection cables (107).

13. The device (100) according to the preceding claim, wherein the device comprises a plurality of heating elements (105) electrically connected to the main housing (101).
